(19) United States
(12) Patent Application Publication
(10) Pub. No.: US 2023/0024616 A1
(43) Pub. Date: Jan. 26, 2023

(54) PILL-CUTTING BOX WITH ELASTIC HOLDER SET

(71) Applicant: 3 Cut Pro LLC, St. Augustine, FL (US)

(72) Inventors: Dat T Dang, Orlando, FL (US); Roy H. Hinman, II, Palm Coast, FL (US)

(21) Appl. No.: 17/382,959

(22) Filed: Jul. 22, 2021

(51) Int. Cl. A61J 7/00

(52) U.S. Cl. CPC A61J 7/0007

(57) ABSTRACT

A pill-cutting box includes an upper shell, a lower shell pivotally connecting the upper shell, a cutter unit in the upper shell, an elastic holder set in the lower shell, and a sliding mechanism between the upper and lower shells. The elastic holder set, consisted of a bottom pad and two side pads, provides a pill-setting room protruded over the lower shell. The sliding mechanism includes a sliding plate to shield the cutter unit. In a cutting process, the upper shell is pivoted to match the lower shell, the sliding plate moves to expose the cutter unit, a pill held by the elastic holder set in the pill-cutting room is sent to meet the cutter unit. With elastic holding by the elastic holder set, the pill can keep its position during the cutting, and thus the pill-cutting result can be much acceptable.

### TECHNICAL FIELD

The present disclosure relates in general to a functional box, and more particularly to a pill-cutting box with an elastic holder set that can prevent a pill to be cut from excessive constraints during a cutting operation.

### BACKGROUND

While in dividing a pill into pieces, generally two pieces, human hands are usually applied to process a bending operation. However, if mass pills are to be divided in a short time, a fatigue problem for the human work would rise to fail a satisfied and in-time job. To overcome such a human factor, a pill-cutting box, or say a bite box, is introduced to handle this mass pill splitting work.

Conventionally, the pill-cutting box, generally made of acrylics, includes an upper half, a lower half pivotally connected to the upper half for forming a complete box structure while these two halves are engaged, a cutter fixed inside the upper half by having a knife edge thereof to face the lower half, and a pill holder set disposed inside the lower half for clamping a pill to openly face the cutter. While in a typical pill-cutting operation, a pill is firstly held firmly by the pill holder at the lower half, and then the upper half is pivoted toward the lower half so as to finally close the pill-cutting box, such that the cutter at the upper half can be pushed or squeezed into the pill while in closing the pill-cutting box. With an appropriate geometric arrangement upon the cutter and the pill holder set, ideally the cutter should cut the pill into two pieces while the upper half is closed onto the lower half.

In the art, the upper half and the lower half including the pill holder set are both produced by injection molding, and made of the same acrylic material. It is well known that the acrylic products provide almost no resilience. Thus, when a pill is held in position by the pill holder set for cutting, two opposite ends of the pill are surely contacted by respective sides of the pill holder set, and importantly the contact between the pill and the acrylic-made pill holder set is solid without elasticity.

Generally speaking, the pill needed to be cut into pieces is a tablet pill, and this tablet pill is usually brittle. For the tablet pill held by the pill holder set, the incoming cutter would be equivalent to a sharp object to cut and to smash the pill itself. Since the pill holder set provides solid contact almost without elasticity to hold the tablet pill, the incoming cutter would engage the tablet pill with a shearing force for cutting, a side push for driving the table pill off the holding position, and a smash for crashing the brittle tablet pill. Inevitably, the tablet pill won't be cut perfectly into two clear equal-size pieces, but into two different main pieces with lots of tiny chips. Obviously, such a pill-cutting result is not acceptable, and barely to meet a medication service.

Thus, an improvement of the convention pill-cutting box to resolve the aforesaid shortcomings is definitely urgent to the skill in the art.

### SUMMARY

Accordingly, it is an object of the present disclosure is to provide a pill-cutting box with an elastic holder set that can hold a pill in an elastic manner, such that the pill can be cut into desired pieces.

Another object of this present disclosure is to provide a pill-cutting box with an elastic holder set that is further furnished with an internal sliding plate for protecting the cutter from being touched while the pill-cutting box is in an open state.

In this disclosure, a pill-cutting box with an elastic holder set has an upper shell and a lower shell pivotally connected with the upper shell at one side thereof. The upper shell provides an upper interior accommodation space, and the lower shell provides a lower interior accommodation space to face the upper interior accommodation space.

The pill-cutting box includes a cutter unit and an elastic holder set. The cutter unit, disposed in the upper interior accommodation space, includes at least one knife blade having a knife edge facing the lower interior accommodation space. The elastic holder set, disposed in the lower interior accommodation space, includes a bottom pad and a pair of side pads standing individually along two opposite sides of the bottom pad to provide a pill-setting room defined by the bottom pad and the pair of side pads and thus located above the lower interior accommodation space by being open to the cutter unit. The bottom pad and the pair of side pads are made of an elastic material.

When a pill is placed on the bottom pad in the elastic holder set/pill-setting room for being cut into pieces, two opposite ends of the pill are individually restrained by the pair of side pads. In an open state of the pill-cutting box, the upper shell is pivotally connected with the lower shell with the upper interior accommodation space separated from both the lower interior accommodation space and the pill-setting room. In a close state of the pill-cutting box, the upper shell is completely engaged with the lower shell with the upper interior accommodation space connected with the lower interior accommodation space, the pill-setting room moved into the upper interior accommodation space, and the cutter unit entering the pill-setting room by having the knife edge to touch the bottom pad.

In one embodiment of this disclosure, the at least one knife blade of the cutter unit includes only knife blade.

In one embodiment of this disclosure, the at least one knife blade of the cutter unit includes two separate knife blades arranged in a predetermined angle.

In one embodiment of this disclosure, the bottom pad and the pair of side pads are three separate pads.

In one embodiment of this disclosure, the bottom pad and the pair of side pads are integrated as a unique foldable piece by connecting webs.

In one embodiment of this disclosure, the elastic material is a rubber.

In one embodiment of this disclosure, the pill-cutting box with an elastic holder set further includes a sliding mechanism mounted between the upper shell and the lower shell. The sliding mechanism includes a sliding plate and a pair of swing links. The sliding plate is mounted slidably to the upper shell and separated from the knife edge. The pair of swing links are arranged parallel to each other and disposed laterally and oppositely to the elastic holder set. Each of the pair of swing links has oppositely a lower end and an upper end. The lower end is pivotally connected to a lower pivot point at the lower shell, and the upper end is pivotally connected to an upper pivot point at the sliding plate.

When reaching to the open state of the pill-cutting box, the upper shell is pivotally rotated to leave the lower shell, and simultaneously each of the pair of swing links is pivoted about the lower pivot point and swings the upper end to pull back the sliding plate along the upper shell to reach a position shielding the cutter unit inside the upper interior accommodation space. When reaching to the close state/cutting state of the pill-cutting box, the upper shell is pivotally rotated to engage the lower shell, and simultaneously each of the pair of swing links is pivoted about the lower pivot point and swings the upper end to push the sliding plate along the upper shell to reach another position leaving the cutter unit and allowing the cutter unit to enter the pill-setting room.

As stated, in the pill-cutting box with an elastic holder set provided by this disclosure, the elastic holder set is utilized to hold the tablet pill in an elastic manner, so that, while the cutter is engaged to perform the cutting, adverse effects caused by the direct shearing, the side push and the hard-contact constraint forcing upon the pill can be substantially buffered and thus reduced. Also, the pill can keep its position during the cutting, and the amount of chips produced due to the cutting would be better controlled. Namely, such a pill-cutting result provided by this disclosure would be much more acceptable.

Further, with the sliding mechanism to provide a shield for the cutter unit while the pill-cutting box is in an open state, the user can be prevented from an accidental cut by the knife edge. Thus, applications of the pill-cutting box of this disclosure can provide sufficient use safety.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic perspective view of a preferred embodiment of the pill-cutting box with an elastic holder set in accordance with this disclosure;

FIG. 2 is a schematic exploded view of FIG. 1;

FIG. 3 demonstrates schematically another exemplary example of the cutter unit for FIG. 1;

FIG. 4 is a schematic side view of FIG. 1 in a close state;

FIG. 5 is a schematic side view of FIG. 1 in an open state; and

FIG. 6 is a schematic perspective view of another exemplary example of the elastic pads for FIG. 1.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

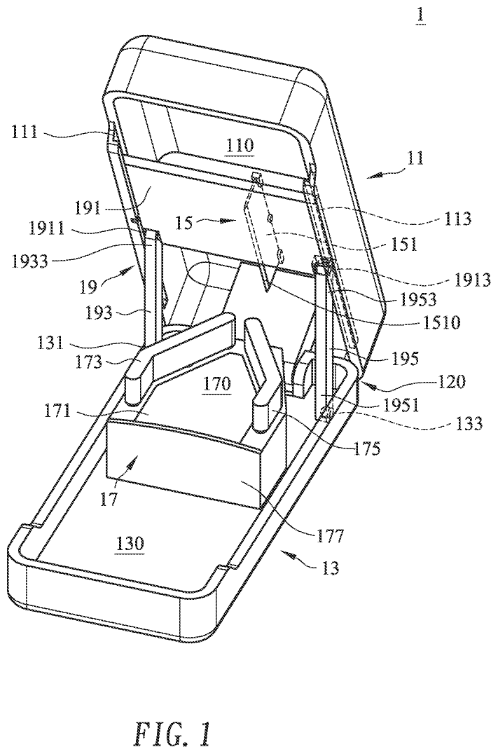

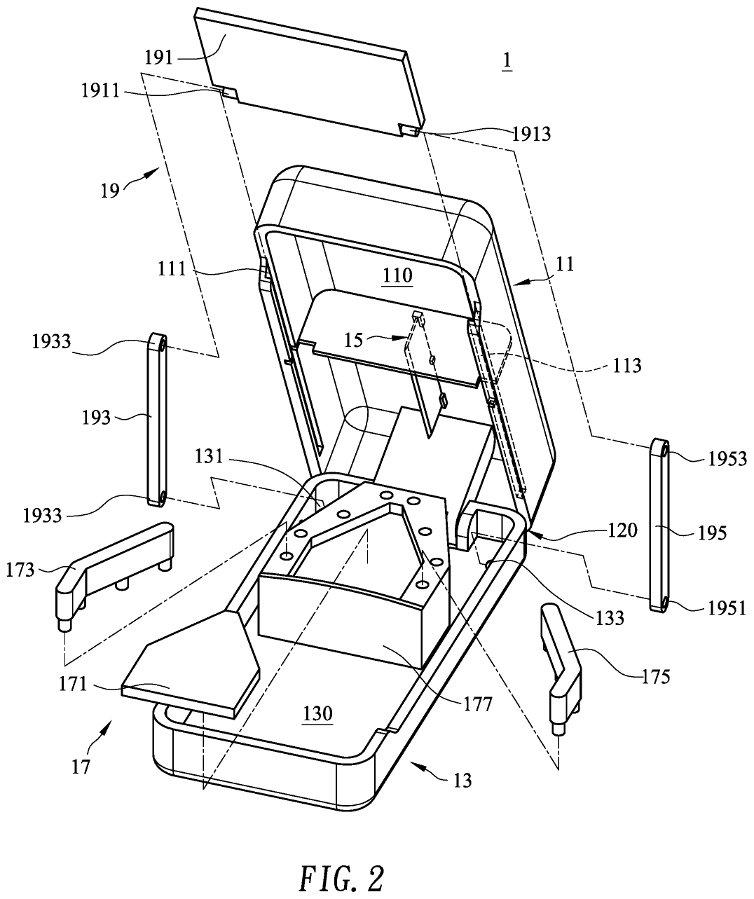

Referring now to FIG. 1 and FIG. 2, a preferred embodiment of the pill-cutting box 1 with an elastic holder set in accordance with this disclosure is shown schematically in a perspective view and an exploded view, respectively. A box body of the pill-cutting box 1 is consisted of an upper shell 11 and a lower shell 13 pivotally connected with the upper shell 11 at one common side 120 of the two shells 11, 13. The upper shell 11 provides thereinside an upper interior accommodation space 110, and the lower shell 13 provides thereinside a lower interior accommodation space 130 to face the upper interior accommodation space 110.

The pill-cutting box 1 includes a cutter unit 15, an elastic holder set 17 and a sliding mechanism 19.

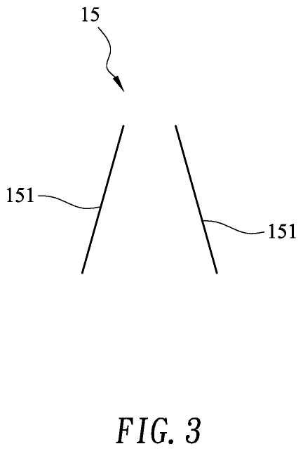

The cutter unit 15, disposed in the upper interior accommodation space 110, includes at least one knife blade 151 having a knife edge 1510 facing the lower interior accommodation space 130. In this embodiment, the cutter unit 15 includes only one knife blade 151. However, in another embodiment shown in FIG. 3, the cutter unit 15 includes two separate knife blades 151 arranged in a predetermined angle.

The elastic holder set 17, disposed in the lower interior accommodation space 130, includes a bottom pad 171 and a pair of side pads 173, 175 standing individually along two opposite sides 1711, 1713 of the bottom pad 171 to provide a pill-setting room 170 defined by the bottom pad 171 and the pair of side pads 173, 175 and thus located above the lower interior accommodation space 130 by being open to the cutter unit 15. The bottom pad 171 and the pair of side pads 173, 175 are made of an elastic material such as a rubber. When a pill (not shown in the figures) is placed in the pill-setting room 170 and on the bottom pad 171 for being cut into pieces, two opposite ends of the pill are individually and elastically restrained by the pair of side pads 173, 175. In addition, in order to elevate the height of the elastic holder set 17 so as to get closer to the upper shell 11, the lower shell 13 is further furnished with an internal installation platform 177 for mounting thereon the elastic holder set 17.

The sliding mechanism 19, theoretically a four-bar linkage in a slider form, is mounted between the upper shell 11 and the lower shell 13. The sliding mechanism 19 includes a sliding plate 191 and a pair of swing links 193, 195. The sliding plate 191 is mounted slidably along corresponding slots 111, 113 at the upper shell 11 and separated from the knife edge 1510. The pair of swing links 193, 195 are arranged parallel to each other and disposed laterally and oppositely to the elastic holder set 17. Each of the pair of swing links 193, 195 has oppositely a lower end 1931 or 1951 and an upper end 1933 or 1953. The lower end 1931 or 1951 is pivotally connected to a lower pivot point 131 or 133 at the lower shell 13, and the upper end 1933 or 1953 is pivotally connected to an upper pivot point 1911 or 1913 at the sliding plate 191.

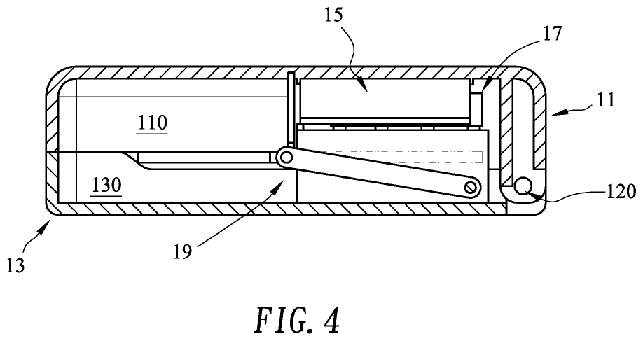

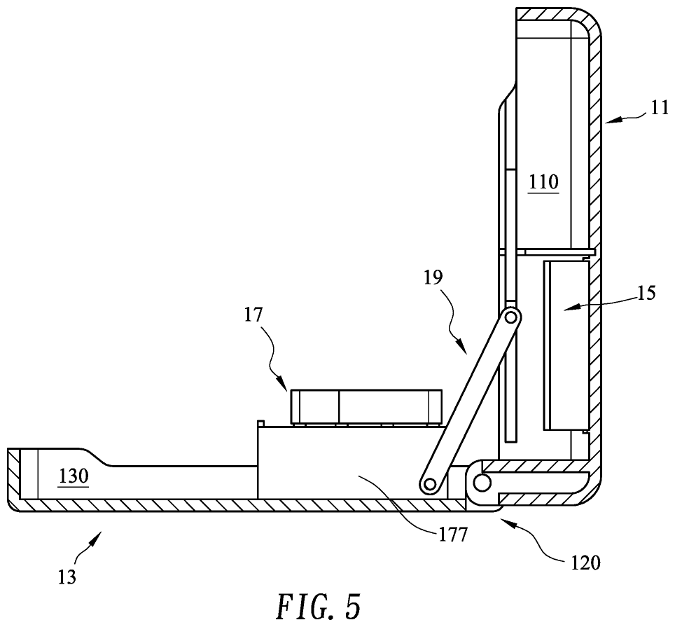

In this disclosure, the pill-cutting box 1 has at least an open state (see FIG. 4) and a close state (See FIG. 5). In the open state of the pill-cutting box 1, the upper shell 11 is pivotally connected with the lower shell 13 only at the common pivotal side 120 and with the upper interior accommodation space 110 separated from both the lower interior accommodation space 130 and the pill-setting room 170.

In the close state of the pill-cutting box 1, the upper shell 11 is completely engaged with the lower shell 13 with the upper interior accommodation space 110 connected with the lower interior accommodation space 130, and with the pill-setting room 170 to move into the upper interior accommodation space 110, so that the cutter unit 15 can enter the pill-setting room 170 by having the knife edge 1510 to touch the bottom pad 171.

To reach the open state of the pill-cutting box 1, the upper shell 11 is pivotally rotated to leave away the lower shell 13, and simultaneously each of the pair of swing links 193, 195 is pivoted about the lower pivot point 131 or 133 and swings the upper end 1933 or 1953 to pull back the sliding plate 191 along the upper shell 11 to reach a position where the sliding plate 191 can shield the cutter unit 15 inside the upper interior accommodation space 110.

On the other hand, to reach the close state of the pill-cutting box 1, the upper shell 11 is pivotally rotated to engage the lower shell 13, and simultaneously each of the pair of swing links 193, 195 is pivoted about the lower pivot point 131 or 133 and swings the upper end 1933 or 1953 to push the sliding plate 191 along the upper shell 11 so as to reach another position where the sliding plate 191 can leave and expose the cutter unit 15 and allow the cutter unit 15 to enter the pill-setting room 170 (or allow the pill-setting room 170 to enter the upper interior accommodation space 110 of the upper shell 11 so as to overlap spatially the cutter unit 15).

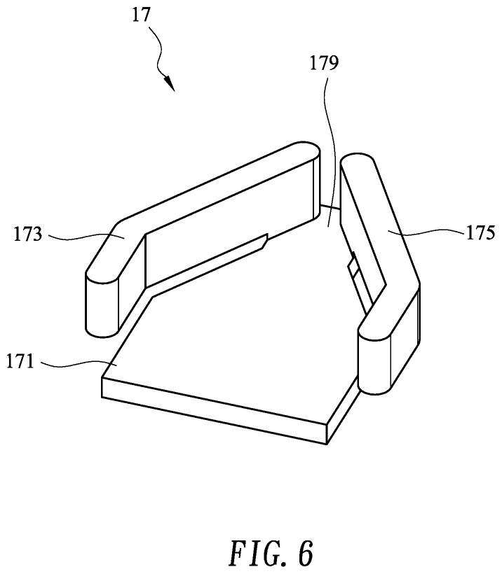

In the embodiment shown in FIG. 1 or FIG. 2, the bottom pad 171 and the pair of side pads 173, 175 are three separate pads. However, in the embodiment shown in FIG. 6, the bottom pad 171 and the pair of side pads 173, 175 are integrated as a unique foldable piece by connecting webs 179.

As described above, in the pill-cutting box 1 provided by this disclosure, the elastic holder set 17 is utilized to hold the tablet pill in an elastic manner, so that, while the cutter unit 15 is engaged to perform the cutting, adverse effects caused by the direct shearing, the side push and the hard-contact constraint forcing upon the pill can be substantially buffered and thus reduced. Also, with the side pads 173, 175 to elastically hold a pill, the pill can keep its position during the cutting, and thus the amount of chips produced due to the cutting would be better controlled. Namely, such a pill-cutting result provided by this disclosure would be much more acceptable.

Further, with the sliding mechanism 19 to provide a shield for the cutter unit 15 while the pill-cutting box 1 is in the open state, the user can be prevented from an accidental cut by the knife edge 1510. Thus, applications of the pill-cutting box 1 of this disclosure can provide sufficient use safety.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A pill-cutting box with an elastic holder set, having an upper shell and a lower shell pivotally connected with the upper shell at one side thereof, the upper shell providing an upper interior accommodation space, the lower shell providing a lower interior accommodation space facing the upper interior accommodation space, the pill-cutting box comprising:
a cutter unit, disposed in the upper interior accommodation space, including at least one knife blade having a knife edge facing the lower interior accommodation space; and
an elastic holder set, disposed in the lower interior accommodation space, including a bottom pad and a pair of side pads standing individually along two opposite sides of the bottom pad, providing a pill-setting room defined by the bottom pad and the pair of side pads to locate above the lower interior accommodation space and be open to the cutter unit, the bottom pad and the pair of side pads being made of an elastic material;
wherein, when a pill is placed on the bottom pad in the pill-setting room for being cut into pieces, two opposite ends of the pill are individually restrained by the pair of side pads;
wherein, in an open state of the pill-cutting box, the upper shell is pivotally connected with the lower shell with the upper interior accommodation space separated from both the lower interior accommodation space and the pill-setting room;
wherein, in a close state of the pill-cutting box, the upper shell is completely engaged with the lower shell with the upper interior accommodation space connected with the lower interior accommodation space, the pill-setting room moved into the upper interior accommodation space, and the cutter unit entering the pill-setting room by having the knife edge to touch the bottom pad.

2. The pill-cutting box with an elastic holder set of claim 1, wherein the at least one knife blade of the cutter unit includes only knife blade.

3. The pill-cutting box with an elastic holder set of claim 1, wherein the at least one knife blade of the cutter unit includes two separate knife blades arranged in a predetermined angle.

4. The pill-cutting box with an elastic holder set of claim 1, wherein the bottom pad and the pair of side pads are three separate pads.

5. The pill-cutting box with an elastic holder set of claim 1, wherein the bottom pad and the pair of side pads are integrated as a unique foldable piece by connecting webs.

6. The pill-cutting box with an elastic holder set of claim 1, wherein the elastic material is a rubber.

7. The pill-cutting box with an elastic holder set of claim 1, further including sliding mechanism mounted between the upper shell and the lower shell, the sliding mechanism including:
a sliding plate, mounted slidably to the upper shell and separated from the knife edge;
a pair of swing links, arranged parallel to each other and disposed laterally and oppositely to the elastic holder set, each of the pair of swing links having oppositely a lower end and an upper end, the lower end being pivotally connected to a lower pivot point at the lower shell, the upper end being pivotally connected to an upper pivot point at the sliding plate;
wherein, to reach the open state of the pill-cutting box, the upper shell is pivotally rotated to leave the lower shell, and simultaneously each of the pair of swing links is pivoted about the lower pivot point and swings the upper end to pull back the sliding plate along the upper shell to reach a position shielding the cutter unit inside the upper interior accommodation space;
wherein, to reach the close state of the pill-cutting box, the upper shell is pivotally rotated to engage the lower shell, and simultaneously each of the pair of swing links is pivoted about the lower pivot point and swings the upper end to push the sliding plate along the upper shell to reach another position leaving the cutter unit and allowing the cutter unit to enter the pill-setting room.

8. A pill-cutting box, having an upper shell and a lower shell pivotally connected with the upper shell at one side thereof, the upper shell providing an upper interior accommodation space, the lower shell providing a lower interior accommodation space facing the upper interior accommodation space, the pill-cutting box comprising:
a cutter unit, disposed in the upper interior accommodation space, including at least one knife blade having a knife edge facing the lower interior accommodation space;
a holder set, disposed in the lower interior accommodation space, providing a pill-setting room protruding from the lower interior accommodation space and open to the cutter unit; and
a sliding mechanism, mounted between the upper shell and the lower shell, including a sliding plate and a pair of swing links, the sliding plate being mounted slidably to the upper shell and separated from the knife edge, the pair of swing links being arranged parallel to each other and disposed laterally and oppositely to the holder set, each of the pair of swing links having oppositely a lower end and an upper end, the lower end being pivotally connected to a lower pivot point at the lower shell, the upper end being pivotally connected to an upper pivot point at the sliding plate;
wherein, when a pill is placed in the pill-setting room for being cut into pieces, two opposite ends of the pill are individually restrained by the holder set;
wherein, in an open state of the pill-cutting box, the upper shell is pivotally connected with the lower shell with the upper interior accommodation space separated from both the lower interior accommodation space and the pill-setting room;
wherein, in a close state of the pill-cutting box, the upper shell is completely engaged with the lower shell with the upper interior accommodation space connected with the lower interior accommodation space, the pill-setting room moved into the upper interior accommodation space, and the cutter unit entering the pill-setting room by having the knife edge to reach a bottom of the pill-setting room;
wherein, to reach the open state of the pill-cutting box, the upper shell is pivotally rotated to leave the lower shell, and simultaneously each of the pair of swing links is pivoted about the lower pivot point and swings the upper end to pull back the sliding plate along the upper shell to reach a position shielding the cutter unit inside the upper interior accommodation space;
wherein, to reach the close state of the pill-cutting box, the upper shell is pivotally rotated to engage the lower shell, and simultaneously each of the pair of swing links is pivoted about the lower pivot point and swings the upper end to push the sliding plate along the upper shell to reach another position leaving the cutter unit and allowing the cutter unit to enter the pill-setting room.

9. The pill-cutting box of claim 8, wherein the holder set is an elastic holder set including a bottom pad and a pair of side pads standing individually along two opposite sides of the bottom pad, the pill-setting room is defined by the bottom pad and the pair of side pads, and the bottom pad and the pair of side pads being made of an elastic material.

10. The pill-cutting box of claim 9, wherein the bottom pad and the pair of side pads are three separate pads.

11. The pill-cutting box of claim 9, wherein the bottom pad and the pair of side pads are integrated as a unique foldable piece by connecting webs.

12. The pill-cutting box of claim 9, wherein the elastic material is a rubber.

13. The pill-cutting box of claim 8, wherein the at least one knife blade of the cutter unit includes only knife blade.

14. The pill-cutting box of claim 8, wherein the at least one knife blade of the cutter unit includes two separate knife blades arranged in a predetermined angle.

15. A pill-cutting box, comprising:
an upper shell;
an lower shell, where the upper shell and the lower shell are pivotally connected;
a holder set for holding a pill;
a cutter unit for cutting the pill, disposed in the upper shell; and
a sliding plate, wherein the sliding plate is slidably mounted on the upper shell for covering the cutter unit, the sliding plate slides to cover the cutter unit when the upper shell and the lower shell are pivotally opened, and the sliding plate slides to uncover the cutter unit when the upper shell and the lower shell are pivotally closed.

16. The pill-cutting box of claim 15, wherein the holder set further comprises a bottom pad and a pair of side pads standing individually along two opposite sides of the bottom pad.

17. The pill-cutting box of claim 15, wherein the holder set is made of rubber.

18. The pill-cutting box of claim 15, further comprising a pair of swing links, wherein the pair of swing links are arranged parallel to each other and disposed laterally and oppositely to the holder set, a first end of each of the pair of swing links pivotally connects to the lower shell, a second end of each of the pair of swing links connects to the sliding plate.
